(19) United States
(12) Patent Application Publication
(10) Pub. No.: US 2014/0095273 A1
(43) Pub. Date: Apr. 3, 2014

(54) BASKET AGGREGATOR AND LOCATOR

(71) Applicants: Paul Tang, Tampa, FL (US); Charles Neighbors, Lakeland, FL (US)

(72) Inventors: Paul Tang, Tampa, FL (US); Charles Neighbors, Lakeland, FL (US)

(73) Assignee: Catalina Marketing Corporation, St. Petersburg, FL (US)

(21) Appl. No.: 13/630,510

(22) Filed: Sep. 28, 2012

(51) Int. Cl. G06Q 30/00; G06Q 30/02

(52) U.S. Cl. 705/14.1; 705/26.8; 705/14.49

(57) ABSTRACT

A system and method for determining a basket, or total, price of items in a shopping list from various retailers is provided. Items may be added to the shopping list based on, for example, a coupon related to an item, items added to the shopping list by a user, items listed in a recipe, and items suggested for the user. The system may determine the price of the items from the various retailers and whether incentives are available for the items. If available and applicable, the incentives are applied to the total price for each retailer and a price comparison of total prices is generated. The price comparison results may be transmitted via various communication channels and may be displayed on a map.

### FIELD OF THE INVENTION

The invention relates generally to determining price comparisons and more particularly to a system and method for determining total prices of various retailers based on a shopping list that includes a plurality of items.

### BACKGROUND OF THE INVENTION

Generally speaking, consumers will seek out the best deals on items such as products or services. However, doing so can be a burdensome process. For example, searching for incentives such as clipping coupons, looking for sales, and keeping track of loyalty program offers (such as offers related to frequent shopper accounts) may be time consuming. Furthermore, comparing regular and sale prices of items from different retailers, whether online or offline brick-and-mortar retailers, can be time consuming and prone to error because a consumer may not take into account unit pricing when comparing prices. Although it may be possible to find price comparisons on a single item, conventional systems fail to provide a comparison of the total cost of a basket, or shopping list, of items from various retailers.

Additionally, the total cost of a shopping list may be influenced by factors other than the price of an item or value of incentives. These factors may not be readily apparent to the consumer, such as the cost of fuel or shipping, associated with obtaining a shopping list of items from the various retailers. Furthermore, non-financial factors such as travel time (e.g., the time it takes to drive to/from a retailer) and shipping time are also not accounted for in conventional pricing systems.

Thus, what is needed is to be able to determine total price comparisons of a shopping list that includes a plurality of items. What is further needed is to be able to account for other factors such as fuel that influence the total price and non-financial factors. What is further needed is to be able to integrate incentive offers such as coupons and loyalty reward programs into the price comparisons. These and other drawbacks exist.

### SUMMARY OF THE INVENTION

The invention addressing these and other drawbacks relates to a system and method for determining a basket, or total, price of items in a shopping list from various retailers. The system may determine the price of the items from the various retailers and whether incentives are available for the items. The system may receive an indication that the user has a coupon that is to be applied to the shopping list. Some incentives such as manufacturer's coupons may be generally applicable to all retailers while other incentives such as loyalty program offers may be retailer-specific. If available and applicable, the incentives may be applied to the total price for each retailer and a price comparison of total prices may be generated. The system may transmit the price comparison results via a webpage, a mobile application, electronic mail, and/or other communication channel.

The system may obtain the shopping list in various ways. For example, the system may communicate an interface such as a webpage that includes a plurality of incentives such as coupons. The system may receive user selections of incentives in which the user is interested and add items related to the incentives to the shopping list The interface may also allow the user to search for coupons of interest and select a coupon of interest when found.

In some implementations, the system may target incentives to a user based on user profile information such as a prior purchase history, demographic information, and/or other information known about the user that may indicate an interest in particular items. The targeted incentives may be communicated to the user. Upon acceptance or selection of a targeted incentive by the user, the system may add an item related to the incentive to the shopping list. In some implementations, the shopping list may be merged or combined with other shopping lists.

In some implementations, the system may receive the shopping list from the user. For example, before, during, and/or after selection of incentives by the user, the system may receive an identification of items from the user to add to the shopping list.

In some implementations, a shopping list may be stored for later use. For example, a stored shopping list may serve as a weekly list that is re-used and/or may be updated to add items, remove items, or update a quantity or size of items. The shopping list may be created based on items listed in a recipe in which the user has indicated an interest. In some implementations, the system may suggest items to add to the shopping list. For example, based on current items in the shopping list or previously purchased items, the system may suggest items to be added to the shopping list as well as search for incentives related to the suggested items.

In some implementations, the shopping list may include items unrelated to other items in the shopping list that necessitates an extra stop. For example, the shopping list may include grocery items and an “oil change” item that indicates that a stop at an oil change service is desired in the same trip. In these implementations, the system may take into account a location of a retailer that provides the unrelated item when providing the price comparison.

The system may identify retailers for which to perform price comparisons in various ways. In some implementations, the retailers may be identified based on user preferences. For example, a user may specify a user location such as a home address, a work address, a location of a user device, and/or other location. The user may also specify a maximum distance and/or travel time that the user is willing to make. In some implementations, the user may specify a preferred retailer location or preferred retailer chains. Based on the user preferences, the system may identify retailers for total price comparisons.

In some implementations, retailers may be identified based on price availability. For example, retailers for which pricing information is unknown will be omitted from the price comparison. In some implementations, the system may also omit retailers that do not carry or have in-stock an item in the shopping list.

In some implementations, the system may alert the user to changes to the price comparison using various communication channels described herein. For example, the system may periodically monitor the shopping list to alert the user of new, expired, or otherwise updated incentives, new or updated prices, and new or updated inventory levels. In this manner, the user may be updated of any change in the price comparison results. The alerts may be pushed and/or pulled. For example, the update (and/or the price comparison results) may be pushed to the user such as when a user device is within a predefined proximity of one of the retailers. The user may also pull the results via a request for the update (and/or the price comparison results).

In some implementations, the system may take into account other factors that affect a cost of making purchases from a retailer. For example, the system may calculate the total cost for each retailer based on fuel prices and distance between the user location and the retailer. In these implementations, the system may obtain fuel usage (e.g., miles-per-gallon) for the user, which may be obtained from the user, stored in the user profile, and/or determined based on a vehicle driven by the user. Based on the fuel usage, distance from the retailer, and fuel price, the system may determine the travel cost incurred by travelling to the retailer. In this manner, the total cost of the trip, including travel cost and total cost for the shopping list, may be determined in relation to one or more retailers. Whether to incorporate travel cost may be user-definable such that the system can toggle on and off the fuel usage feature. In some implementations, the travel cost may be separately displayed and/or may be incorporated into the total price.

In some implementations, the system may optimize the price comparisons based on a maximum number of stops or maximum amount of travel time that the user is willing to make. For example, the user profile may include an indication that the user is willing to make a maximum of two stops. In this case, the system may optimize the total cost over at most two retail locations.

In some implementations, the system may determine the optimum total cost across multiple retailers even if the user specified a maximum of one stop (or by default, has not specified a maximum at all). In these implementations, the system may transmit an indication of the amount of potential savings and related retailers to the user. For example, the system may transmit a message “you could save money if you make your purchases across two stores.” In this manner, the user may be informed of the potential savings if more than one stop is made. In each of the foregoing optimum total cost examples, fuel costs and/or inventory information may be factored into the decision as well.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a system of comparing total costs of a plurality of items from various retailers, according to an aspect of the invention.

FIG. 2 illustrates a data flow diagram for comparing total costs of a plurality of items from various retailers, according to an aspect of the invention.

FIG. 3 illustrates a process for shopping list price comparisons, according to an aspect of the invention.

FIG. 4 illustrates a process for communicating incentives for a user and determining price comparison results for items related to selected incentives, according to an aspect of the invention.

FIG. 5 illustrates a screenshot of an interface for receiving coupon selections, according to an aspect of the invention.

FIG. 6 illustrates a screenshot of an interface for searching for coupons, according to an aspect of the invention.

FIG. 7 illustrates a screenshot of an interface that includes a price comparison result, according to an aspect of the invention.

FIG. 8 illustrates a price comparison result, according to an aspect of the invention

FIG. 9 illustrates a screenshot of an interface 900 that includes a price comparison result, according to an aspect of the invention.

FIG. 10 illustrates a screenshot of an interface that includes a price comparison result, according to an aspect of the invention.

### DETAILED DESCRIPTION OF THE INVENTION

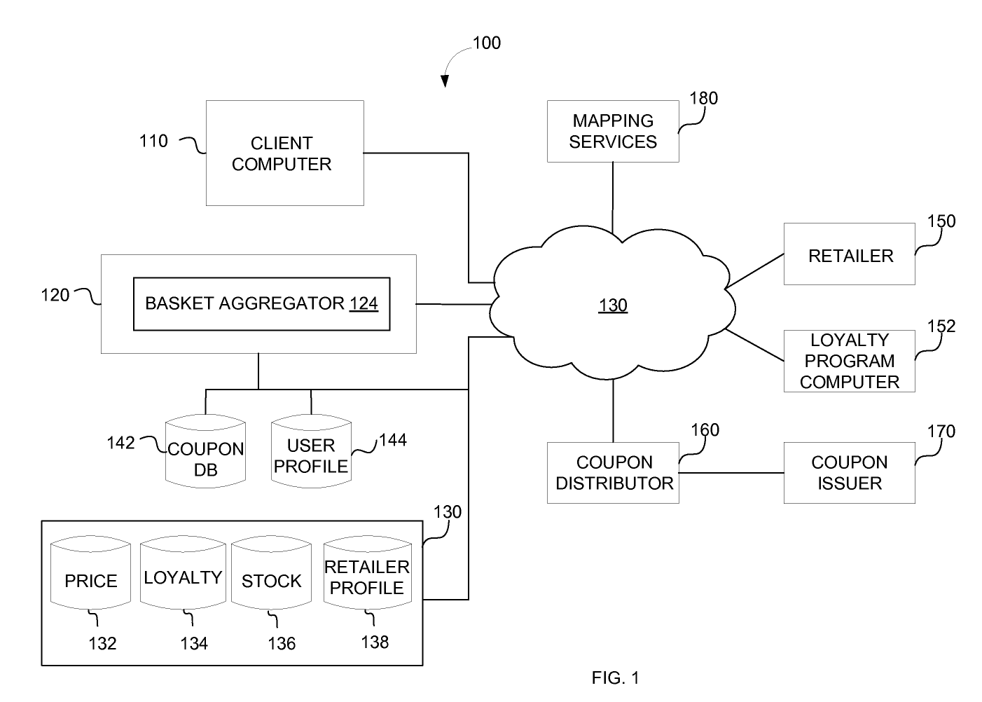

FIG. 1 illustrates a system 100 of comparing total costs of a plurality of items from various retailers, according to an aspect of the invention. Generally speaking, system 100 may identify one or more retailers and calculate a total cost of the plurality of items offered by each of the identified retailers. Using the system, a user may obtain the total cost for the plurality of items by inputting a shopping list of products and/or services in which the user is interested. As used herein, the term “user” can refer to a single person, more than one person such as a household, and/or an entity such as a company or organization.

The retailers may be identified based on a user-specified parameter such as a maximum distance and/or travel time that the user is willing to travel from a user location, a maximum number of stops (e.g., at retailers) that the user is willing to make, an indication of favorite or preferred retailer locations, and/or other parameter that limits or otherwise affects identification of the retailers used for price comparison. The user location may include a location associated with a user such as a home address, a work address, a current location of a device of a user, a route, and/or other location. The user location may be specified using an address, a city, a zip code, a geographic coordinate (e.g., latitude/longitude), and/or other indication of a location.

In some implementations, system 100 may determine the total cost based on incentives such as coupons that are available for one or more of the items, discounts available through a loyalty program, general sales, and/or other available offers. System 100 may transmit the total costs and identification of corresponding retailers using various communication channels such as a website or via a mobile application on a device associated with the user.

The foregoing are merely examples of implementations and uses of the system. Other uses and implementations will now be described with respect to various system components.

Client computer 110 may include a desktop computer, a laptop, a cell phone, a smart phone, a Personal Digital Assistant, a pocket PC, or other device that a user may use to communicate with computer 120. For example, client computer 110 may communicate with computer 120 via various communication channels such as electronic mail, voice call, Short Message Service (SMS) text messaging, the Internet (e.g., via a web page), social networks, etc. A user may use client computer 110 to interface with the system such as by inputting one or more shopping lists, viewing and redeeming one or more incentives, printing or otherwise receiving a coupon, receiving total cost comparison results, viewing a map of one or more retail locations, viewing directions to retail locations, printing the map or directions, and/or otherwise communicating with the system.

Computer 120 may comprise one or more computing devices configured with a basket aggregator 124 that enables the various features and functions of the invention, as described in greater detail below. Computer 120 may include a webserver (not illustrated in FIG. 1) that may be used to expose an interface such as a webpage that a user or others may use to communicate with computer 120.

Those having skill in the art will recognize that computer 120 may comprise a processor, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data that may be manipulated by the processor. The storage devices may comprise floppy disks, hard disks, optical disks, tapes, or other storage devices for storing computer-executable instructions and/or data.

One or more applications, including the basket aggregator, may be loaded into memory and run on an operating system of computer 120. In one implementation, computer 120 may comprise a server device, a desktop computer, a laptop, a cell phone, a smart phone, a Personal Digital Assistant, a pocket PC, or other device.

Computer 120 may include or otherwise access one or more databases. In some implementations, computer 120 may obtain information associated with retailers from retailer information databases 130, which may include, for example, a price database 132, a loyalty program database 134, a stock or inventory database 136, and a retailer profile database 138. In some implementations, computer 120 may obtain incentive information from coupon database 142 and information associated with a user from user profile database 144.

Price database 132 may be configured to store item identifications (e.g., UPC codes), prices (e.g., regular prices, sale prices, unit prices, etc.), size or quantity information, retailer identifications, general specials such as double-coupon offers, and/or locations of retailers (e.g., addresses). In this manner, computer 120 may determine a price of an item and/or other information associated with the item for a given retailer. In some implementations, price database 132 may be configured to store fuel prices from fuel retailers such as gas stations. In this manner, in some implementations, computer 120 may take into account the cost of fuel when determining price comparisons. In some implementations, the price database may be updated periodically or in real-time by the retailer, consumers, and/or other price-gathering methods.

Loyalty program database 134 may be configured to store loyalty program offers (e.g., incentives available for frequent shopper card holders), account information for frequent shoppers, shopping histories, redemption histories, and/or other information associated with a loyalty program. In this manner, computer 120 may determine prices based on loyalty offers in addition to regular or sale prices.

Inventory database 136 may be configured to store items carried by a retailer as well as an inventory of items of the retailer. In this manner, computer 120 may determine whether a retailer carries an item and whether the item is in stock. For example, if one or more items in the shopping list are not in stock for a particular retailer, computer 120 may ignore the retailer or otherwise provide an indication to the user that the item is not in stock at the retailer.

Retailer profile database 138 may be configured to store information relating to a retailer. The stored information may include, for example, a location of the retailer (e.g., address, geo-coordinates, etc.), a type of retailer (e.g., grocery, sporting goods, etc.), whether the retailer uses a loyalty program, hours of operation, and/or other information. In this manner, computer 120 may determine whether a retailer is within range of a user location for price comparisons as well as be used as a basis for querying by computer 120.

Coupons database 142 may be configured to store coupons and incentives, such as from coupon distributor 160 and/or coupon issuer 170. In this manner, computer 120 may determine whether a coupon is available for an item so that any discount offered by the coupon may be applied when determining the total cost. In some implementations, the coupon may be retail-specific so that only the total cost of the retailer offering the coupon is affected in the total cost comparison. In some implementations, the coupons or other incentives may be based on a distance to travel to a retailer. For example, the incentive may be greater for a location that is further from the user than a location that is closer.

User profile database 144 may be configured to store a user profile. The user profile may include, for example, shopping lists, a user identification, a user location, a shopping history, a coupon redemption history, a payment account identifier (such as a de-identified and/or encrypted payment account identifier), a loyalty program membership, a user preference such as a maximum distance or time that the user is willing to travel, a maximum number of stops that the user is willing make, and/or other information or preferences of a user.

Retailer computer 150 may include a server device, a desktop computer, a laptop, or other device used for retailer operations such as point of sale operations. Retailer computer 150 may communicate with or otherwise include a loyalty program device 152 use to retrieve offers for loyalty card members.

Coupon distributor 160 may include a server device, a desktop computer, a laptop, or other device used for distributing coupons. Coupon issuer 170 may include a server device, a desktop computer, a laptop, or other device used for issuing coupons to be distributed by coupon distributor 160. As would be appreciated, a coupon clearinghouse (not illustrated in FIG. 1) may facilitate payments between the coupon issuer and retailer that accepted the coupon. In some implementations, computer 120 may serve as the coupon clearinghouse.

Mapping service 180 may include a server device, a desktop computer, a laptop, or other device used for mapping operations, which may include determining for two or more locations, a distance between the locations, a travel time between the locations, a map of the locations, a route between the locations, and/or directions between the locations.

Network 130 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), or other network.

The foregoing description of the various components comprising system architecture 100 is exemplary only, and should not be viewed as limiting. The invention described herein may work with various system configurations. Accordingly, more or less of the aforementioned system components may be used and/or combined in various implementations.

Having provided a non-limiting overview of exemplary system architecture 100, the various features and functions enabled by computer 120 will now be explained.

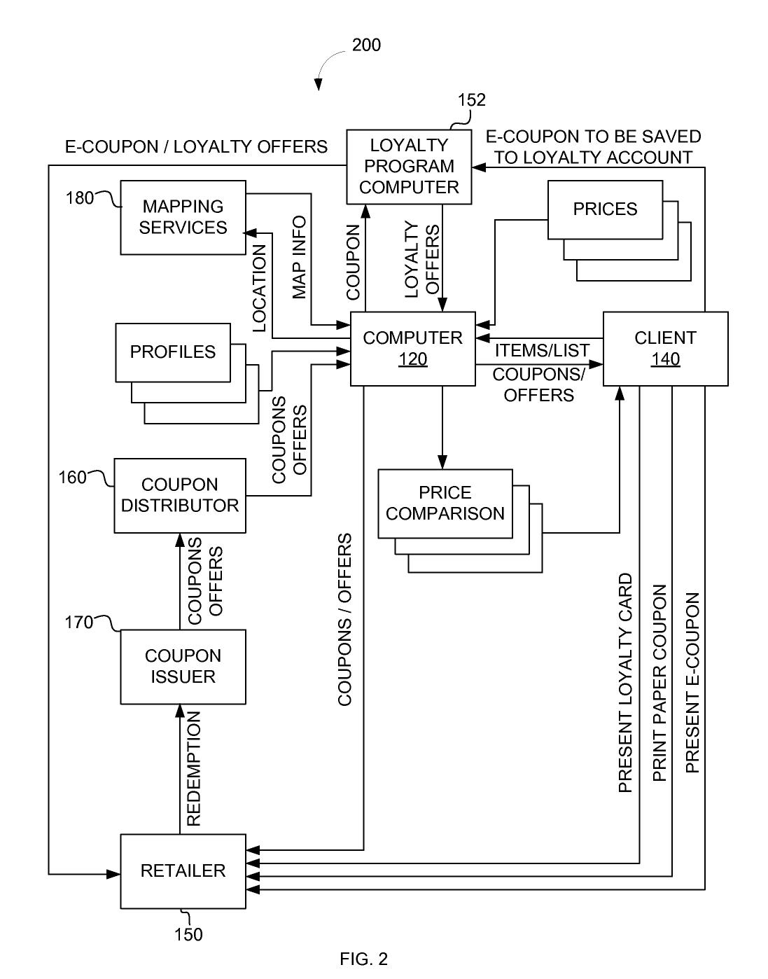

FIG. 2 illustrates a data flow diagram 200 for comparing total costs of a plurality of items from various retailers, according to an aspect of the invention. In some implementations, computer 120 may obtain a user profile from user profile database 144 to determine a user location and other information associated with the user to determine total cost comparisons among different retailers for the user.

In some implementations, computer 120 may obtain a list of a plurality of items, which may be obtained in various ways. For example, a user may create a new shopping list using client device 140, which communicates the shopping list to computer 120. The user may update an existing shopping list (such as a weekly shopping list) stored at the client device and/or at computer 120 by adding, removing, or otherwise updating items in the shopping list.

In some implementations, computer 120 may create a new shopping list or update an existing list based on one or more incentives such as coupons accepted by the user. Computer 120 and/or coupon distributor 160 may target the user to receive the incentives based on the user profile and/or items in a shopping list. The incentives may be communicated to client device 140, which the user may use to accept an incentive. Upon acceptance, computer 120 may add an item related to the accepted incentive to a shopping list or the user may simply add the item to the shopping list if the user is interested in the incentive.

The accepted coupon may be conveyed to retailer 150 in various ways. In some implementations, computer 120 may communicate an electronic coupon (illustrated in FIG. 2 as “E-COUPON”) to retailer 150 via client device 140. In these implementations, computer 120 may communicate the electronic coupon to client device 140, which may store the electronic coupon. When in the proximity of retailer 150, client device 140 may transmit the electronic coupon to the retailer via a wireless or wired connection. In some implementations, computer 120 may transmit coupon information to be printed by client device 140, in which case the coupon may be used as a printed “paper” coupon. In some implementations, computer 120 and/or client device 140 may cause an indication of the coupon acceptance to be communicated to loyalty program device 152, which may store the indication for retailer 150. In these implementations, when the user makes a purchase using an associated loyalty card at retailer 150, the coupon may be automatically applied to the purchase.

When updating an existing shopping list, computer 120 may suggest items to add to and/or delete from the shopping list such as by determining one or more incentive offers related to the item to be added or deleted. The incentive offers may be based on the user profile and/or based on items currently in the shopping list. For example, computer 120 may determine that an item such as cereal is in the shopping list but that a related item such as milk is not in the shopping list. Computer 120 may determine incentive offers for the related item. The user may accept the incentive offer, which may cause computer 120 to place the promoted item on the shopping list or the user may simply add the promoted item to the list. In another example, computer 120 may determine that the user typically purchases a particular item during the first week of the month. If the particular item is not in a shopping list created by the user during the first week of a month, computer 120 may provide a suggestion or reminder to add the item to the shopping list.

Computer 120 may suggest items to delete from the shopping list based on upcoming sales or incentives. For example, computer 120 may determine that an item on the shopping list will be on sale next week, and may suggest removing the item from the shopping list.

In some implementations, computer 120 may identify one or more retailers based on the user profile. For example, computer 120 may determine retailers that are within the user location such as within a user-defined maximum distance or within a user-defined maximum travel time. As would be appreciated, travel times may vary based on traffic conditions and type of roadway (e.g., city or highway), which may be accounted for when determining which retailers satisfy the user-defined criteria. The retailers may be determined by communicating retailer location information and user location information to mapping service 180, which may determine a distance and/or travel time between the user and the retailer. In some implementations, computer 120 may identify a retailer based on a favorite retailer or list of preferred retailers specified by the user and stored in the user profile.

In some implementations, computer 120 may determine a price for each of the plurality of items at the one or more retailers and a distance or travel time to the one or more retailers. For example, computer 120 may obtain the price of each of the items from retailer information databases 130. Computer 120 may also obtain incentive or discount information from various sources that may be applied to the price of an item. For example, computer 120 may receive coupons from coupon distributor 160 and/or coupon issuer 170, loyalty program offers from loyalty program device 152, and/or other incentive offers. In some implementations, a user may enter coupons or coupon codes into client device 140, which communicates the coupons to computer 120. In these implementations, computer 120 may determine whether the coupon is valid. If valid, computer 120 may discount the price of a related item based on the coupon.

For each of the retailers, computer 120 may calculate a total cost of the plurality of items based on the determined price. The total cost may reflect applied coupons, loyalty program offers and/or other incentives. Computer 120 may also determine whether a particular retailer has ancillary offers such as “double coupon days” related to a coupon or other incentive.

Computer 120 may transmit the total cost and an indication of the distance or travel time. The transmission may be made via a website, an email, and/or other communication channel through which computer 120 may transmit data to client 110. The total cost and indication of the distance or travel time may be transmitted based on different display modes. For example, computer 120 may determine the lowest total cost for the shopping list among the one or more retailers and may display only the retailer having the lowest total cost. Computer 120 may sort or rank the retailers based on lowest total costs and may display all or a portion of the sorted retailers. Computer 120 may display either or both of the foregoing retailers in a list format and/or may overlay indications of each retailer onto a map. Each overlaid indication may also include the total cost, distance, and/or travel time related to the retailer.

In some implementations, computer 120 may alert the user to changes to the price comparison using various communication channels described herein. Computer 120 may periodically monitor the shopping list to alert the user of new, expired, or otherwise updated incentives, new or updated prices, and new or updated inventory levels. In this manner, the user may be updated any change in the price comparison results. The alerts may be pushed and/or pulled. For example, the update (and/or the price comparison results) may be pushed to the user such as when a user device is within a predefined proximity of one of the retailers. The user may also pull the results via a request for the update (and/or the price comparison results).

In some implementations, computer 120 may calculate the total cost for each retailer based on fuel prices and distance between the user location and the retailer. In these implementations, computer 120 may obtain fuel usage (e.g., miles-per-gallon) for the user, which may be obtained from the user, stored in the user profile, and/or determined based on a vehicle driven by the user. Based on the fuel usage, distance from the retailer, and fuel price, computer 120 may determine the travel cost incurred by travelling to the retailer. In this manner, the total cost of the trip, including travel cost and total cost for the shopping list, may be determined in relation to one or more retailers. Whether to incorporate travel cost may be user-definable such that the user can toggle on and off the fuel usage feature. In some implementations, the travel cost may be separately displayed and/or may be incorporated into the total price.

In some implementations, the shopping list may include items unrelated to other items in the shopping list that necessitates an extra stop. For example, the shopping list may include grocery items and an “oil change” item that indicates that a stop at an oil change service is desired in the same trip. In these implementations, computer 120 may take into account a location of a retailer that provides the unrelated item when providing the price comparison. Computer 120 may do so by providing mapping service 180 with the user location, the original retailer location, and a location of the retailer that provides the unrelated item. In this manner, a route with total driving distance and/or travel time may be generated. The total driving distance and/or travel time may be used to eliminate or otherwise rank retailers. Furthermore, the total driving distance may be used to take into consideration fuel costs, as described above.

In some implementations, computer 120 may optimize the price comparisons based on a maximum number of stops or maximum amount of travel time that the user is willing to make. For example, the user profile may include an indication that the user is willing to make a maximum of two stops. In this case, computer 120 may optimize the total cost over at most two retail locations.

Computer 120 may execute a linear regression or other algorithm for analyzing prices from different retailers to arrive at the lowest total cost for the shopping list across the maximum number of retailers. In this manner, a user who is willing to make, for example, two stops at two different retailers may purchase items on the shopping list from two retailers who, combined, offer the lowest total cost compared to a single retailer alone or other combinations of retailers. Similarly, a user who is willing to travel a maximum of, for example, 30 minutes may receive price comparison results across any number of retailers that results in a travel time less than the specified maximum travel time. The maximum number of stops and the maximum travel time may be combined such that a user may specify, for example, a maximum of two stops and no more than thirty minutes travel time. Of course, even if a maximum number of stops greater than one is specified, if a single retailer offers the lowest price, then that will be reflected in the price comparison results. For example, single and multi-retailer results may be displayed together and sorted by total cost/distance/travel time. Furthermore, the lowest total cost of either a single retailer or multiple retailers may be identified and transmitted.

In some implementations, computer 120 may determine the optimum total cost across multiple retailers even if the user specified a maximum of one stop (or by default, has not specified a maximum at all). In these implementations, computer 120 may transmit an indication of the amount of potential savings and related retailers to the user. For example, computer 120 may transmit a message “you could save money if you make your purchases across two stores.” In this manner, the user may be informed of the potential savings if more than one stop is made. In each of the foregoing optimum total cost examples, fuel costs and/or inventory information may be factored into the decision as well.

In some implementations, computer 120 may operate with unregistered users. For example, computer 120 may present an interface such as a web page that provides coupons that can be selected by any user who visits the web page. The user may input a location (or other user profile information) such as a zip code, coordinate, etc., and receive price comparisons from nearby retailers based on the selected coupons and profile information that the user input.

In some implementations, computer 120 may operate with registered users who have registered with the system such as providing user profile information to be stored by computer 120. In these implementations, a registered user may login or provide other credentials to use the system.

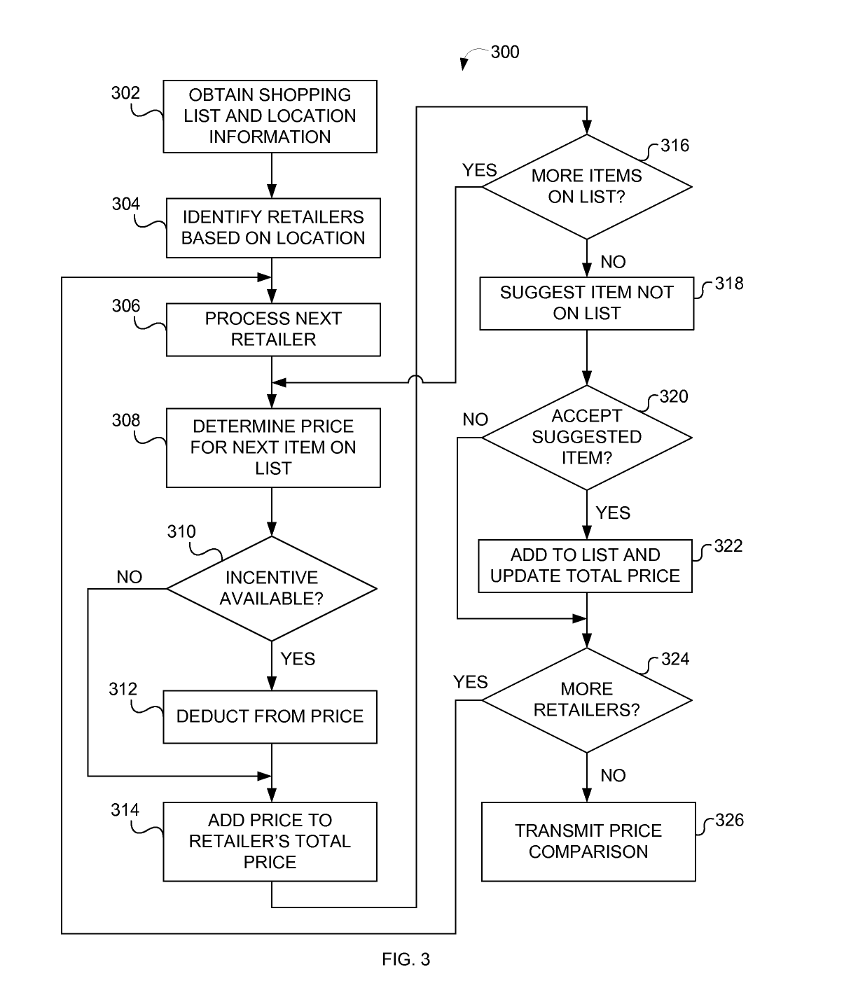

FIG. 3 illustrates a process 300 for shopping list price comparisons, according to an aspect of the invention. The various processing operations and/or data flows depicted in FIG. 3 (and in the other drawing figures) are described in greater detail herein. The described operations may be accomplished using some or all of the system components described in detail above and, in some embodiments, various operations may be performed in different sequences. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 302, process 300 may include obtaining a shopping list and a user location. The user location may include an address, a city, a zip code, a geographic coordinate, a route, and/or other information that can specify a location. The location information may define a user's home address, a user's work address, a user's current location (such as a location of a device of the user), and/or other location from which the user would like to receive price comparisons. Process 300 may obtain the user location and/or the shopping list from a memory such as from user profile database 144, from a request that includes the user location and/or the shopping list as input, and/or from other sources that can provide the user location.

In an operation 304, process 300 may include identifying one or more retailers based on the user location. For example, process 300 may identify retailers that are within a specified distance or travel time away from the user location. The location of the retailers may be obtained from retailer profiles and/or other sources of information that includes a location of the retailer. In some implementations, process 300 may identify the one or more retailers based on inventory information available for the retailers. For example, process 300 may identify a retailer based on its proximity to the user location and whether the retailers carry items from the shopping list and/or have the items currently in stock.

Process 300 may iterate through the identified one or more retailers. As such, in an operation 306, process 300 may include processing the next retailer. For each retailer, process 300 may iterate through each item of the shopping list to determine the price offered by the retailer. Accordingly, in an operation 308, process 300 may include determining a price for the next item on the shopping list.

In an operation 310, process 300 may include determining whether an incentive or other offer is available for the item. In some implementations, the incentive or other offer may be received from the user. For example, the user may upload an electronic coupon or otherwise indicate that the user wishes to redeem a coupon for an item on the shopping list. In some implementations, the incentive or other offer may be obtained from a database of offers targeted for the user. In some implementations, the coupon or other incentive may be obtained from a loyalty reward program or indication that the item is on sale at the particular retailer.

If an incentive or other offer is available for the item, process 300 may proceed to an operation 312, where the incentive or other offer is deducted from the price, if applicable. If the offer or other incentive includes a coupon, the coupon may be communicated to the user as an electronic coupon and/or a coupon to be printed. The coupon may also be stored at an account associated with the user (e.g., a loyalty program account).

If the incentive includes conditions, process 300 may verify that the conditions have been met. For example, a buy one get one free offer may have the condition that two items are purchased. In this example, process 300 may validate whether the shopping list includes at least two of the items before deducting a price of one of the items from the total price of two of the items. Other conditions may be similarly validated. Processing may then proceed to an operation 314. Returning to operation 310, if an incentive or other offer is not available for the item, process 300 may proceed to operation 314.

In operation 314, process 300 may include adding the price of the item to a total price for the retailer. In an operation 316, process 300 may include determining whether more items are on the shopping list. If more items are on the shopping list, processing may return to operation 308, where the price of the next item on the shopping list is determined. On the other hand, if no more items are on the shopping list, process 300 may proceed to an operation 318, where one or more items not on the shopping list may be suggested. For example, a suggested item may be related to an item on the shopping list, an item being generally promoted, and/or may be an item for which the user may be interested based on the user profile. The suggested item may itself be on sale or have an incentive or other offer associated with it.

In an operation 320, process 300 may include determining whether the user accepted the suggested item. For example, the user may have agreed to add the suggested item to the shopping list and/or accepted a coupon related to the suggested item. If the user accepted the suggested item, process 300 may include adding the suggested item to the shopping list and adding the price of the suggested item to the total for the retailer as well as totals for retailers already processed in an operation 322. If the suggested item is associated with a coupon, process 300 may communicate the coupon to the user and/or retailer. Process 300 may store the coupon in an account associated with the user. Processing may proceed to an operation 324. Returning to operation 320, if the user did not accept the suggested item, processing may proceed to operation 324.

In operation 324, process 300 may include determining whether more retailers are to be processed. If more retailers are to be processed, processing may return to operation 306. If no more retailers are to be processed, in an operation 326, process 300 may communicate the price comparison results. The price comparison results may include may include the total price, individual items and their prices/quantities/etc., applied discounts or other incentives, and/or other information that was obtained or determined about the retailer.

In some implementations, process 300 communicates only the retailer having a particular characteristic (which may be specified by the user in the user profile) such as having the lowest total basket price, being the closest, etc. In other implementations, process 300 communicates other identified retailers and their total price.

In some implementations, process 300 communicates the price comparison results for the identified retailers on a map, with indicators that include information from the price comparison results such as the total price for a retailer, the distance or travel time to the retailer, inventory information, guidance routes to the retailer, hours of operation, and/or other information known or determined about the retailer.

In some implementations, operation 326 may include determining estimated fuel use and/or cost based on a distance and/or type of road to travel to a retailer. The price comparison results may include the fuel use and/or cost of fuel. In this manner, process 300 may incorporate fuel costs associated travelling to the retailer when determining a total price for the retailer.

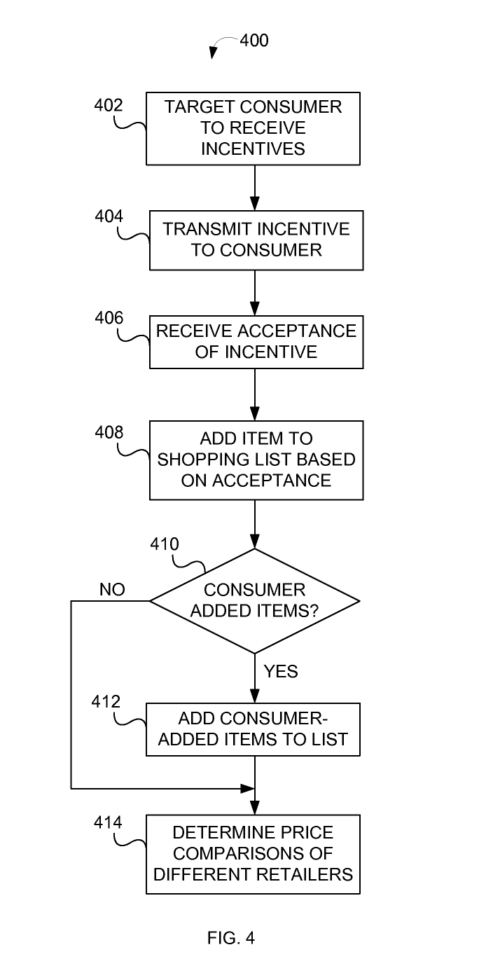

FIG. 4 illustrates a process 400 for communicating incentives for a user and determining price comparison results for items related to selected incentives, according to an aspect of the invention. In an operation 402, process 400 may include determining one or more offers to be communicated to a user. For example, the offers may be related to a category of items in which the user is interested, a particular brand in which the user is interested, featured brands or categories, and/or other groupings of coupons. In some implementations, process 400 may include targeting one or more offers or incentives for a user. For example, based on a user profile of the user, process 400 may determine a coupon for an item in which the user may be interested. The user profile may include a prior purchase history, a prior offer redemption history, demographics information, and/or other user behavior or information that indicates a potential interest in the item. In some implementations, the user may search for coupons based on category, geography, brand, and/or other parameter related to an item or retailer.

In an operation 404, process 400 may include communicating the one or more offers or incentives to the user. The communication may be made via one or more communication channels such as, for example, a web page, an electronic mail, a Short Message Service (“SMS”) text message, a voice call, paper mail, electronic coupon, and/or other communication channel that can convey an offer or incentive. For example, process 400 may include communicating a web page that includes selectable offers/incentives such as coupons to the user.

In an operation 406, process 400 may include receiving an acceptance of an incentive from the user. For example, the user may indicate an interest in the incentive. The acceptance may be received via one or communication channels described above with respect to operation 404. In the example given in operation 404, for instance, the user may select one or more offers/incentives from the web page, thereby electronically “clipping” the offer/incentive for use. In some implementations, the coupon may be communicated to the user for printing and/or for storing on a device of a user for redemption. In some implementations, the accepted coupon may be communicated to the retailer and/or a loyalty account associated with the user.

In an operation 408, process 400 may include adding an item related to the accepted incentive to a shopping list for the user. For example, based on an accepted coupon for milk, process 400 may add milk to the shopping list. In doing so, process 400 may determine a volume/quantity required by the coupon and add the required volume/quantity to the shopping list. In this manner, process 400 may build a shopping list based on user selections of incentives/offers while keeping track of the incentives/offers in relation to the items in the shopping list.

In an operation 410, process 400 may determine whether the user would like to add other items to the shopping list. If in operation 410 the user has added another item to the shopping list, process 400 may add the item to the shopping list in operation 412. For example, using the foregoing web page a user may input one or more items to be added to the shopping list. In another example, the user may input a coupon code or other offer code. In this example, process 400 may add an item related to the coupon code or offer code to the shopping list. Processing may proceed to an operation 414, where a price comparison is determined based on the shopping list and/or any incentives/offers. The price comparison may include one or more of various processing operations described above in relation to process 300.

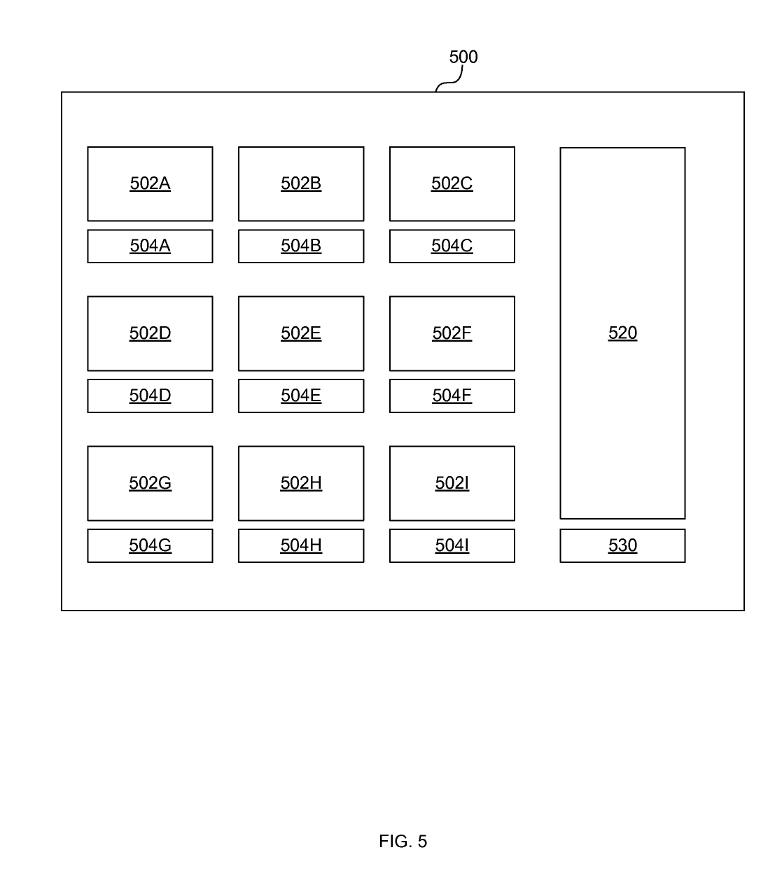

FIG. 5 illustrates a screenshot of an interface 500 for receiving incentive selections, according to an aspect of the invention. The screenshots illustrated in FIG. 5 and other drawing figures are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and as such, should not be viewed as limiting.

Interface 500 and other interfaces described herein may be implemented as a web page communicated from computer 120 to a client, an application such as a mobile application executing on the client that receives generates the interface based on information communicated from computer 120, and/or other interface. Whichever type of interface is used, computer 120 may communicate the data and/or formatting instructions related to the interface to the client, causing the client to generate the various interfaces of FIG. 5 and other drawing figures. Furthermore, computer 120 may receive data from the client via the various interfaces, as would be appreciated.

In some implementations, interface 500 may include a plurality of incentive presentation portions 502 (illustrated in FIG. 5 as incentive presentation portions 502A, 502B, . . . , 502I). Incentive presentation portion 502 may display information related to an incentive such as a coupon and/or an item related to the incentive. For example, the displayed information may include image, text, incentive conditions, and/or other content.

In some implementations, interface 500 may include action elements 504 (illustrated in FIG. 5 as action elements 504A, 504B, . . . , 504I). Action element 504 may include one or more actions that the user may select or otherwise input with respect to the incentive displayed in a corresponding incentive presentation portion 502. The one or more actions may include, for example, queuing or otherwise causing the incentive to be printed, adding an item related to the incentive to the shopping list, loading the incentive to an account associated with a loyalty card, saving the incentive to a user profile, and/or performing other action related to the incentive.

Computer 120 may receive an indication of the one or more actions and may cause an item related to the corresponding incentive to be added to the shopping list, which may then be used to determine price comparisons among different retailers, as described herein. Thus, in some implementations, interface 500 may be used as a gateway to performing price comparisons on selected items via selected incentives. For example, a user may select various coupons from interface 500 and receive price comparisons of different retailers that offer items related to the selected coupons. In this manner, the user may electronically clip coupons and determine lowest priced retailers for a shopping list that includes items related to the electronically clipped coupons. As would be appreciated, the client may respond to the one or more actions such as causing an item related to a corresponding incentive to be added to the shopping list, which may then be communicated to computer 120.

In some implementations, interface 500 may include a savings wallet 520, which may display information associated with available savings or offers. For example, savings wallet 520 may display available savings for a registered user, loyalty program rewards for a user enrolled in a loyalty program, available savings for the user, available coupons (including printable coupons) for the user, coupons selected by the user (e.g., via action elements 504) and/or other information related to the user.

Interface 500 may include a price comparison command element 530, which may cause coupon selections, a shopping list based on the coupon selections, and/or other information to be communicated to computer 120. For example, the selected coupons and/or shopping list may be encoded as a form at interface 500, which gets submitted via HTTP to computer 120. Computer 120 may receive the selected coupons and/or shopping list and perform price comparisons for items related to the selected coupons and/or items on the shopping list as described herein.

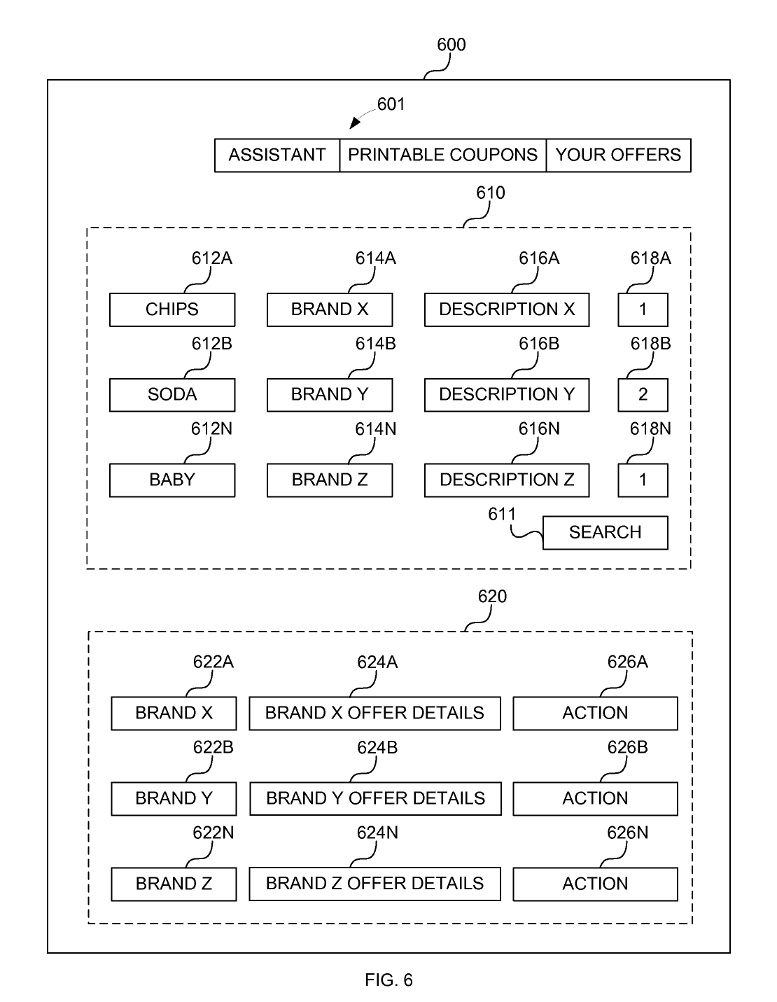

FIG. 6 illustrates a screenshot of an interface 600 for searching for coupons, according to an aspect of the invention. In some implementations, interface 600 may include a toolbar 601, which may include a shopping assistant that allows searching for incentives by category, brand, product, and/or other parameter that may be used to search for an item related to an incentive.

In some implementations, interface 600 may include a search portion 610, which may be used to input search parameters. Search parameters may include a category search 612 (illustrated in FIG. 6 as category search 612A, 612B, . . . , 612N), brand search 614 (illustrated in FIG. 6 as brand search 614A, 614B, . . . , 614N), and product search 616 (illustrated in FIG. 6 as product search 616A, 616B, . . . , 616N). Category search 612 may be used to select or otherwise input different categories of items related to incentives. For example, a category may include a “CHIPS” category, which causes a search for incentives related to chips, or other categories such as “SODA” and “BABY.” Brand search 614 may be used to select or otherwise input different brands of items related to incentives. Product search 616 may be used to select or otherwise input particular products such as a brand and size. In some implementations, quantity input 618 (illustrated in FIG. 6 as quantity input 618A, 618B, . . . , 618N) may be used to select or otherwise input a quantity of item desired. A submit input 611 may cause a search request to be communicated to, for example, computer 120, where the search may be executed. The search results may be communicated back to the client and presented via interface 600.

In some implementations, interface 600 may include a results portion 620, which may be used to display search results. For example, based on the search input parameters from search portion 610, interface 600 may display product descriptions 622 (illustrated in FIG. 6 as product descriptions 622A, 622B, . . . , 622N), incentive offer 624 (illustrated in FIG. 6 as product descriptions 624A, 624B, . . . , 624N), and action element 626 (illustrated in FIG. 6 as product descriptions 626A, 626B, . . . , 626N).

Product description 622 may describe a product that matches one or more of the search parameters. Incentive display 624 may describe an incentive and/or conditions for the incentive for the matching products. Action element 626 may include one or more actions that the user may select or otherwise input with respect to the incentive displayed in a corresponding incentive display 624. The one or more actions may include, for example, queuing or otherwise causing the incentive to be printed, adding an item related to the incentive to the shopping list, loading the incentive to an account associated with a loyalty card, saved to a user profile, and/or other action to be performed. In some implementations, the search results may include a related item if no perfect matches are found. For example, if the user requested incentives for brand X but no incentives are available for brand X, the search results may include available incentives for competing brand Y.

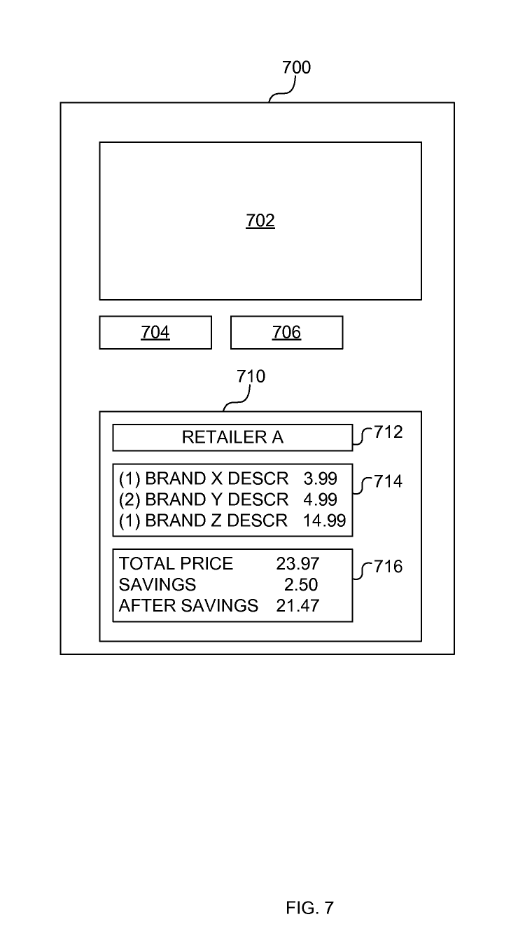

FIG. 7 illustrates a screenshot of an interface 700 that includes a price comparison result 710, according to an aspect of the invention. In some implementations, interface 700 may include a savings wallet 702 similar to the savings wallet illustrated in FIG. 5. Interface 700 may include a user interface element 704 that when selected causes a request for a price comparison of different retailers for a shopping list that includes items, such as items that were selected using user interface 600. The request may be communicated to computer 120, which may generate and communicate a price comparison result 710. User interface element 706 when selected may cause coupons selected using interface 600 to be printed and/or may cause the coupons to be communicated as an electronic coupon.

As illustrated in FIG. 7, price comparison result 710 may display the best deal (e.g., a retailer having the lowest total price, the closest in distance, and/or the least travel time). Price comparison result 710 may include retailer information 712 that identifies and/or describes the retailer associated with the best deal. The retailer information may include, for example, an address, coordinate, phone number, hours of operation, and/or other information known or obtainable about the retailer.

Item detail 714 may include item information that describes the items in the shopping list. The item information may include, for example, a brand, a quantity, a price, an inventory level, and/or other information about the item. In some implementations, item detail 714 may include the price for an item after all discounts and incentives have been applied. Totals portion 716 may include total prices (before applied incentives), savings from applied incentives, total after savings, and/or other information about the total for the shopping list.

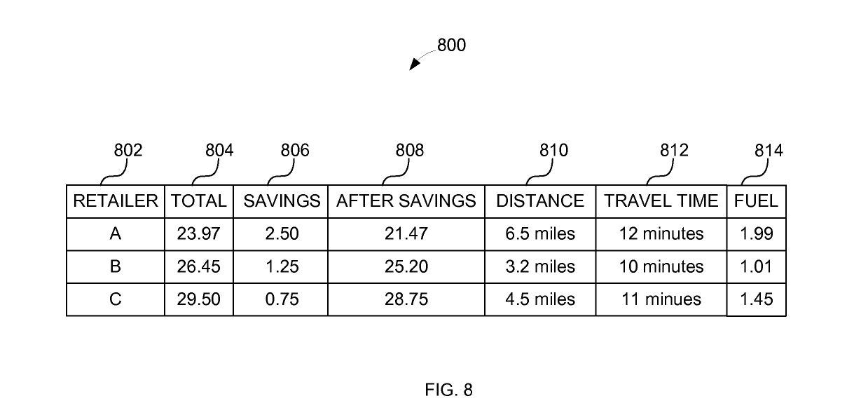

FIG. 8 illustrates a price comparison result 800, according to an aspect of the invention. In some implementations, price comparison result 800 may include various columns, including, for example, retailers 802, corresponding total prices 804 for the shopping list, a total savings 806, a total after savings 808, a distance to travel 810, a travel time 812, and a fuel cost 814. In some implementations, total after savings 808 may include fuel cost 814, which estimates the cost of fuel to travel to and/or from the retailer 802. As illustrated in FIG. 8, three retailers A, B, and C are compared in the price comparison result.

As would be appreciated, interface 800 may be included along with (e.g., on the same display screen) other interfaces of other screenshots. The price comparison result illustrated in FIG. 8 may also include other columns for other information such as, for example, retailer information (e.g., store hours, address, inventory information, etc.), fuel usage, and/or other information described herein.

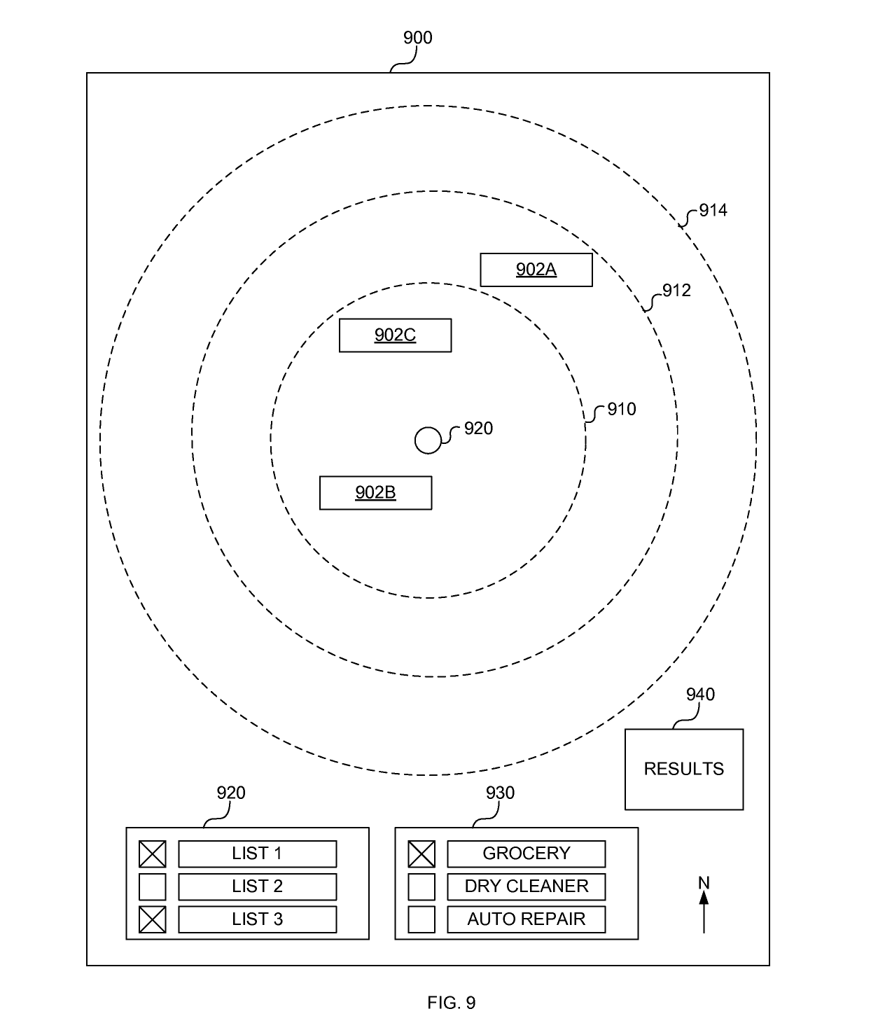

FIG. 9 illustrates a screenshot of an interface 900 that includes a price comparison result, according to an aspect of the invention. Interface 900 may be implemented as a map display, which may include price comparison results displayed on a map. The map may include a user location indicator 920, which indicates an address, coordinate, or other location used as the basis for searching nearby retailers. As illustrated in FIG. 9, the price comparison result includes three retailers indicated using graphical indicia 902 (illustrated in FIG. 9 as indicia 902A, 902B, 902C). Graphical indicia 902 may include one or more of the information presented by the table of FIG. 8 and/or other information related to the retailer such as an identity, location, link to obtain directions, routes, etc. In this manner, the user may view the price comparison results on a map.

In some implementations, as illustrated, interface 900 may include radius indicators 910, 912, and 914, which may indicate a radius from user location 920. In some implementations, interface 900 may include a list selector 920, which allows a user to select price comparison results for different shopping lists. As illustrated, “LIST 1” and “LIST 3” are selected. In this example, two shopping lists may be combined so that a price comparison result is displayed for the combined items. If a conflict is detected such as redundant items on two different lists, computer 120 may cause interface 900 to prompt the user to resolve the conflict such as indicating whether the redundant items should be removed.

In some implementations, interface 900 may include trip type selector 930, which may allow the user to filter price comparison results by type of trip related to a shopping list (which can include service items such as car repairs). In some implementations, interface 900 may include results 940, which may include information illustrated in FIG. 8 and/or other information related to the price comparison results. Selection of more than one type of trip may cause a request to be transmitted to computer 120, which may re-compute the price comparison results, taking into account any newly added type of trips.

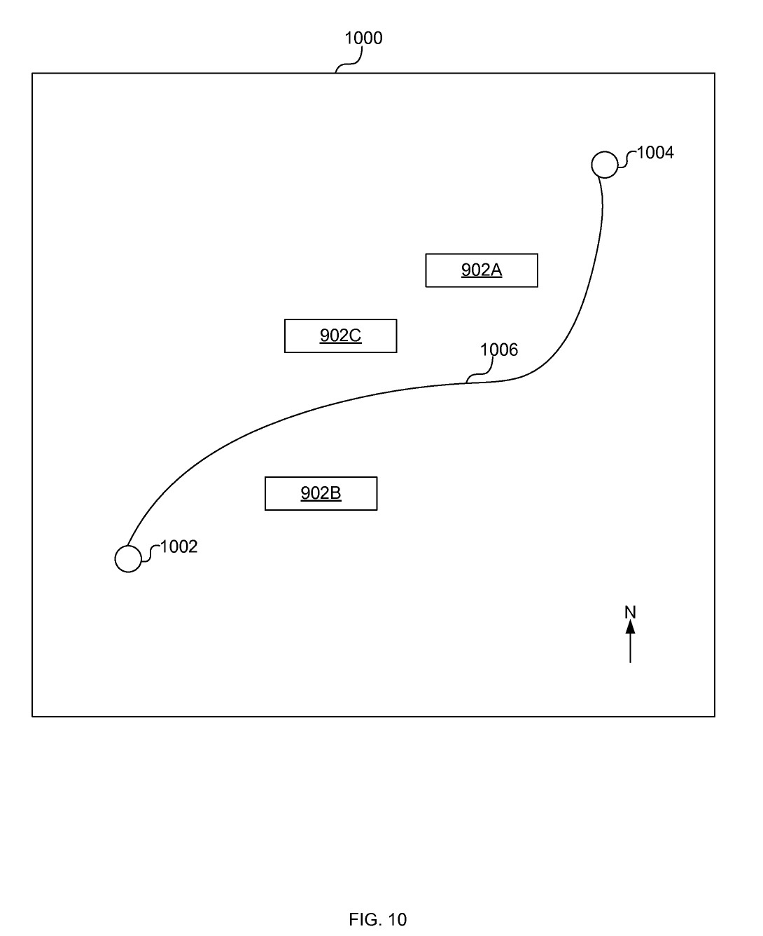

FIG. 10 illustrates a screenshot of an interface 1000 that includes a price comparison result, according to an aspect of the invention. Interface 1000 is similar to interface 900 except that price comparison results for retailers nearby or along a route 1006 between start location 1002 and end location 1004 are displayed. In this manner, the user may view results of retailers nearby or along a route as opposed to nearby a particular location. A retailer (which can include service providers and other entities) may be nearby when they are within a predefined distance or radius of a point along the route. Although not illustrated in FIG. 10, interface 1000 may include elements similar to interface 900 such as radius indicators 910, 912, 914 (such as a radius from a point on the route), list selector 920, trip type selector 930, and/or results 940.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for determining and locating price savings for a plurality of items, comprising:
obtaining, by a computer, a list of a plurality of items from a user and a user location;
identifying, by the computer, one or more retailers based on the user location;
determining, by the computer, a price for each of the plurality of items at the one or more retailers and a distance or travel time to the one or more retailers;
calculating, by the computer, for each of the one or more retailers, a total cost of the plurality of items based on the determined price; and
transmitting, by the computer, the total cost and the distance or travel time to the one or more retailers.

2. The method of claim 1, wherein calculating the total cost comprises:
determining, by the computer, whether an incentive is available for any one of the plurality of items; and
calculating, by the computer, the total cost based on the availability of the incentive.

3. The method of claim 2, the method further comprising:
transmitting, by the computer, incentive information to be printed or an electronic coupon associated with the incentive.

4. The method of claim 1, the method further comprising:
receiving, by the computer from a user, an incentive that the user wishes to redeem;
determining, by the computer, whether the incentive is redeemable; and
applying, by the computer, the incentive to the total cost when the incentive is redeemable.

5. The method of claim 1, the method further comprising:
determining, by the computer, a retailer having the lowest total cost, wherein the total cost and the distance to the one or more retailers is transmitted for only the retailer having the lowest total cost.

6. The method of claim 1, wherein transmitting the total cost and the distance or travel time to the one or more retailers further comprising:
transmitting, by the computer, the total cost and the distance or travel time sorted by the total cost.

7. The method of claim 1, the method further comprising:
determining, by the computer, an incentive for an item not on the list of the plurality of items; and
offering, by the computer, the incentive.

8. The method of claim 7, the method further comprising:
receiving, by the computer, an acceptance of the incentive; and
adding, by the computer, the item not on the list of the plurality of items to the list of the plurality of items based on the acceptance.

9. The method of claim 8, the method further comprising:
re-calculating, by the computer, the total cost based on the added item.

10. The method of claim 1, the method further comprising:
determining, by the computer, whether each one of the plurality of items is in stock at each one of the one or more retailers; and
excluding, by the computer, a retailer that does not have an item in stock.

11. A computer for determining and locating price savings for a plurality of items, comprising:
a processor configured to:
obtain a list of a plurality of items from a user and a user location;
identify one or more retailers based on the user location;
determine a price for each of the plurality of items at the one or more retailers and a distance or travel time to the one or more retailers;
calculate, for each of the one or more retailers, a total cost of the plurality of items based on the determined price; and
transmit the total cost and the distance or travel time to the one or more retailers.

12. The system of claim 11, wherein the processor is further configured to:
determine whether an incentive is available for any one of the plurality of items; and
calculate the total cost based on the availability of the incentive.

13. The system of claim 12, wherein the processor is further configured to:
transmit incentive information to be printed or an electronic coupon associated with the incentive.

14. The system of claim 12, wherein the processor is further configured to:
receive, from a user, an incentive that the user wishes to redeem;
determine whether the incentive is redeemable; and
apply the incentive to the total cost when the incentive is redeemable.

15. The system of claim 11, wherein the processor is further configured to:
determine a retailer having the lowest total cost, wherein the total cost and the distance to the one or more retailers is transmitted for only the retailer having the lowest total cost.

16. The system of claim 11, wherein the processor is further configured to:
transmit the total cost and the distance or travel time sorted by the total cost.

17. The system of claim 11, wherein the processor is further configured to:
determine an incentive for an item not on the list of the plurality of items; and
offer the incentive.

18. The system of claim 17, wherein the processor is further configured to:
receive an acceptance of the incentive; and
add the item not on the list of the plurality of items to the list of the plurality of items based on the acceptance.

19. The system of claim 18, wherein the processor is further configured to:
re-calculate the total cost based on the added item.

20. The system of claim 11, wherein the processor is further configured to:
determine whether each one of the plurality of items is in stock at each one of the one or more retailers; and
exclude a retailer that does not have an item in stock.
